(19) United States
(12) Patent Application Publication
(10) Pub. No.: US 2012/0280647 A1
(43) Pub. Date: Nov. 8, 2012

(54) BATTERY RECHARGING STATION FOR USE IN A BAR

(76) Inventor: Dale Perez, Cuyahoga Falls, OH (US)

(21) Appl. No.: 13/462,383

(22) Filed: May 2, 2012

Related U.S. Application Data
(60) Provisional application No. 61/481,862, filed on May 3, 2011.

(51) Int. Cl. H02J 7/00; H01R 43/00

(52) U.S. Cl. 320/107; 29/825

(57) ABSTRACT

A battery charging station may be used with a bar having a counter-top surface on one side of the bar and a drink rail portion on the other side. The battery charging station may include a body having a bottom surface and at least one foot that has a width that is equal to or less than the width of the drink rail portion. The battery charging station may also include at least one phone charging tip and at least one advertisement. Because the battery charging station is supported to the drink rail portion, it does not interfere with the counter-top surface.

This patent claim priority from provisional patent application U.S. Ser. No. 61/481,862, titled BATTERY RECHARGING STATION FOR USE IN A BAR, filed May 3, 2011 which is incorporated in its entirety herein by reference.

### I. BACKGROUND OF THE INVENTION

A. Field of Invention

The invention relates to a device for charging electronic equipment, such as cellular phones, and is ideally suited for use at a bar.

B. Description of the Related Art

It is known to provide battery charging stations that can charge multiple cellular phones simultaneously. It is also known to provide a battery charging station that includes an advertising display which is easily seen by users of the battery charging station.

Known battery charging stations, however, are known to have problems. One such problem is their use in a bar. Known battery charging stations are large and take up valuable space on the counter-top of the bar. This is undesirable as the counter-top is used by patrons to support their beverages while seated at the bar. Another difficulty is that known battery charging stations, when used in a bar, are easily susceptible to spilled beverages. Because bar tenders frequently pass out beverages to the patrons, both new and re-filed, it is common for beverages to spill on the counter-top of the bar. Since battery charging stations contain electrical components, the spilling of a beverage on a battery charging station can be dangerous for the patrons.

What is needed, then, is a battery charging station that can be easily used in bars without occupying valuable counter-top space and that are unlikely to encounter a spilled beverage.

### II. SUMMARY

According to one embodiment of this invention, a battery charging station may be used with an associated bar having first and second sides, a counter-top surface on the first side of the bar for use in supporting beverages of patrons sitting at the first side of the bar and a drink rail portion on the second side of the bar for use in holding emptied drinking receptacles. The drink rail portion may comprise a drink rail surface that is recessed from the counter-top surface and has a width W1. The battery charging station may comprise: a body having a bottom surface, first and second substantially horizontal surfaces that are not coplanar and first and second substantially vertical surfaces that are not coplanar; a first foot positioned on a first end of the body that extends from the bottom surface of the body, the first foot having a width W2 that is equal to or less than the width W1; and, a second foot positioned on a second end of the body that extends from the bottom surface of the body, the second foot having a width W3 that is equal to or less than the width W1. The first and second feet support the battery charging station to the drink rail surface and prevent the bottom surface from contacting the drink rail surface. The battery charging station may also comprise: a first phone charging tip that: (1) is supported to the body; (2) extends from the first substantially horizontal surface; (3) supports a first associated cellular phone having a battery to the body; and, (4) charges the battery of the first associated cellular phone; a second phone charging tip that: (1) is supported to the body; (2) extends from the second substantially horizontal surface; (3) supports a second associated cellular phone having a battery to the body; and, (4) charges the battery of the second associated cellular phone; a first advertisement that: (1) is supported to the body; (2) is positioned on the first substantially vertical surface; and, (3) faces the patrons sitting at the first side of the bar when the battery charging station is supported to the drink rail surface; and, a second advertisement that: (1) is supported to the body; (2) is positioned on the second substantially vertical surface; and, (3) faces the patrons sitting at the first side of the bar when the battery charging station is supported to the drink rail surface.

According to another embodiment of this invention, a battery charging station may be used with an associated bar having first and second sides, a counter-top surface on the first side of the bar for use in supporting beverages of patrons sitting at the first side of the bar and a drink rail portion on the second side of the bar for use in holding emptied drinking receptacles. The drink rail portion may comprise a drink rail surface that is recessed from the counter-top surface and has a width W1. The battery charging station may comprise: a body having a bottom surface; a first foot that: (1) extends from the bottom surface of the body; (2) has a width W2 that is equal to or less than the width W1; (3) supports the battery charging station to the drink rail surface; and, (4) prevents the bottom surface from contacting the drink rail surface; a first phone charging tip that: (1) is supported to the body; (2) supports a first associated cellular phone having a battery to the body; and, (3) charges the battery of the first associated cellular phone; a second phone charging tip that: (1) is supported to the body; (2) supports a second associated cellular phone having a battery to the body; and, (3) charges the battery of the second associated cellular phone; and, a first advertisement that: (1) is supported to the body; (2) faces the patrons sitting at the first side of the bar when the battery charging station is supported to the drink rail surface; and, (3) is at least 5 inches long. The battery charging station may: (1) have a maximum length of 10 inches or less; (2) have a maximum width of 4 inches or less; and, (3) have a maximum height of 4 inches or less.

According to yet another embodiment of this invention, a method may comprise the steps of: (A) providing a bar having first and second sides and comprising: a counter-top surface on the first side of the bar for use in supporting beverages of patrons sitting at the first side of the bar; and, a drink rail portion on the second side of the bar for use in holding emptied drinking receptacles, the drink rail portion comprising a drink rail surface that is recessed from the counter-top surface; and, has a width W1; (B) providing a battery charging station comprising: a body having a bottom surface; a first foot that extends from the bottom surface of the body and has a width W2 that is equal to or less than the width W1; a first phone charging tip that is supported to the body; a second phone charging tip that is supported to the body; and, a first advertisement that is supported to the body; (C) supporting the battery charging station to the drink rail portion by placing the first foot onto the drink rail surface so that: (1) the bottom surface is prevented from contacting the drink rail surface; and, (2) the first advertisement faces the patrons sitting at the first side of the bar; (D) attaching a power cord from an associated electrical outlet to the body; and, (E) engaging a first associated cellular phone having a battery to one of the first phone charging tip and the second phone charging tip to: (1) support the first associated cellular phone to the body; and, (2) charge the battery of the first associated cellular phone.

Still other benefits and advantages of the invention will become apparent to those skilled in the art to which it pertains upon a reading and understanding of the following detailed specification.

### III. BRIEF DESCRIPTION OF THE DRAWINGS

The invention may take physical form in certain parts and arrangement of parts, embodiments of which will be described in detail in this specification and illustrated in the accompanying drawings which form a part hereof and wherein:

FIG. 1 is a first perspective view generally showing a front and top of an exemplary embodiment of the invention.

FIG. 2 is a second perspective view generally showing a rear and bottom of the exemplary embodiment of the invention;

FIG. 3 is a third perspective view generally showing a rear and top of the exemplary embodiment of the invention.

FIG. 4 is a front view of the exemplary embodiment of the invention.

FIG. 5 is a bottom view of the exemplary embodiment of the invention.

FIG. 6 is a side view of a billboard frame that can be engaged with the exemplary embodiment of the invention.

FIG. 7 is a front view of the billboard frame shown in FIG. 6.

FIG. 8 is a perspective view of the exemplary embodiment of the invention engaged with a billboard frame and bearing indicia for advertising.

FIG. 9 is a side view of the exemplary embodiment of the invention mounted in the drink rail portion of a bar.

FIG. 10 is a perspective view of a power cord that may be used with this invention.

FIG. 11 is a perspective view of suction cups that may be used with this invention.

### IV. DETAILED DESCRIPTION

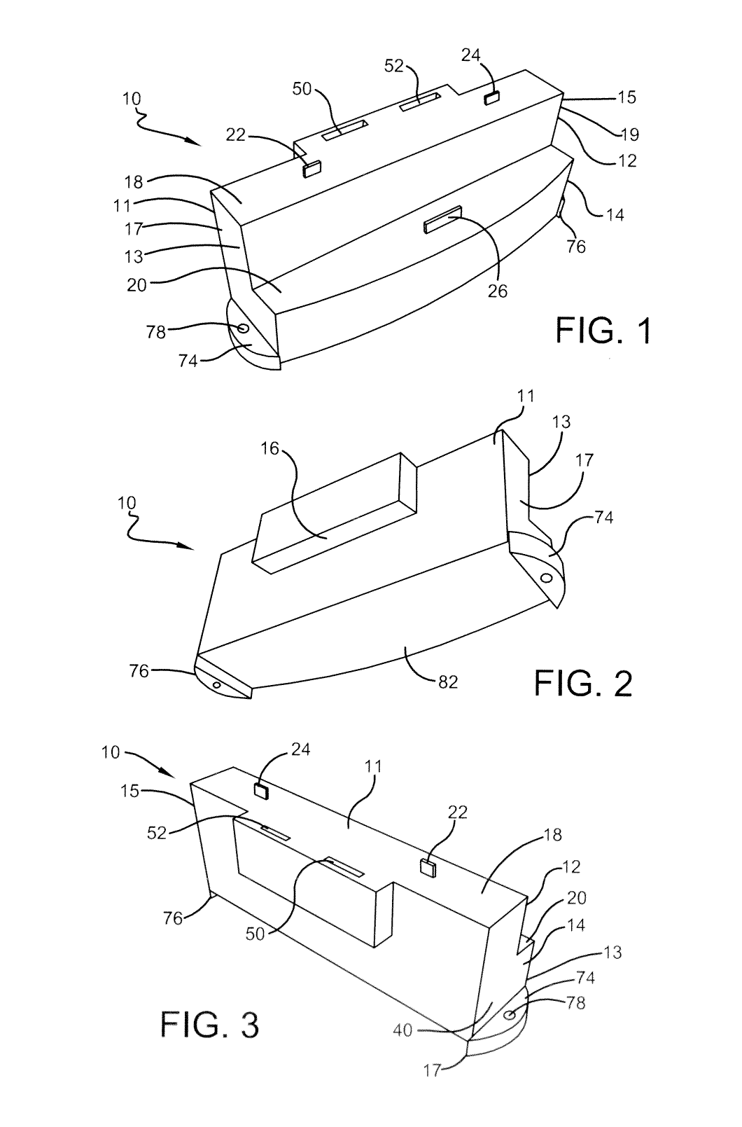

Referring now to the drawings wherein the showings are for purposes of illustrating embodiments of the invention only and not for purposes of limiting the same, and wherein like reference numerals are understood to refer to like components, FIGS. 1-5 show various views of one embodiment of the invention. The battery recharging station 10 has a body 11 having a bottom surface 82, first and second substantially vertical surfaces 12, 14 and first and second substantially horizontal surfaces 18, 20.

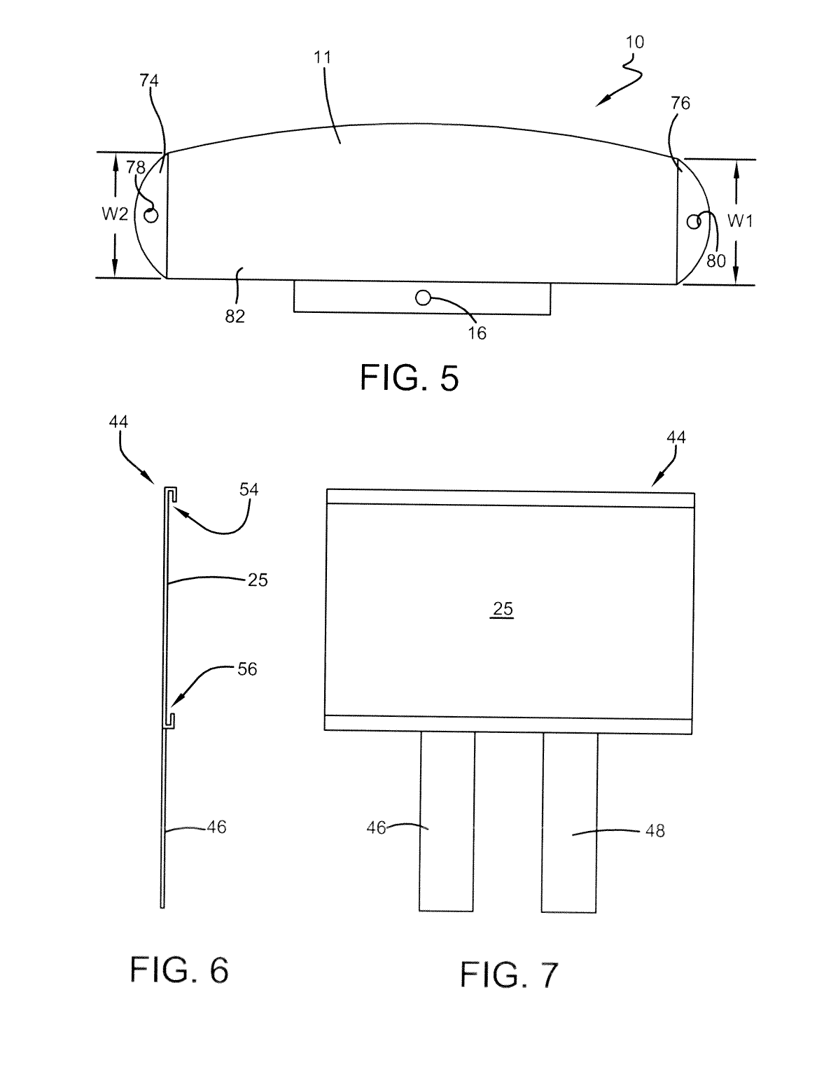

With reference to FIGS. 1, 4 and 8, surfaces 12 and 14 may be used to support advertisements in several different ways. For example, printed materials can be adhered to one or both of the surfaces 12, 14. Alternatively, liquid crystal displays (LCDs) can be mounted on one or both of the surfaces 12, 14. Alternatively, light emitting diodes (LEDs) can be mounted to extend through one or both of the surfaces 12, 14. Electrical power for electronic advertising and for charging can be directed to an interior of the battery recharging station 10 through an aperture 16 (shown in FIGS. 2 and 5). Circuitry for controlling electronic advertising can be housed within the battery recharging station body 11. Alternative embodiments of the invention can include more than two surfaces for supporting advertisements or can have a single surface for supporting advertising. For the embodiment shown, the first and second substantially vertical surfaces 12, 14 are not coplanar. In this way they provide two distinct advertisement surfaces.

With reference now to FIGS. 1, 3, 4, 8 and 9, surfaces 18 and 20 may be used to support electronic equipment being charged by the battery recharging station 10. The battery recharging station 10 can include a plurality of electronic male phone charging tips, three phone charging tips 22, 24, 26 shown, fixedly mounted relative to, and extending from, the surfaces 18 and 20. The charging tips can be used to charge a plurality of cellular phones simultaneously. The phone charging tips 22, 24, 26 can be selected to mate with any cellular phone chosen with the sound judgment of a person of skill in the art. In one embodiment, all the charging tips are identical. In another embodiment, the charging tips vary so that the battery recharging station 10 can mate with, and charge, a plurality of different model phones. For the embodiment shown, the phone charging tip 26 may be configured to mate with, and charge the battery of, an iPhone®. The phone charging tips 22, 24, as shown, may each be micro USB charging tips. While three charging tips are shown, it should be noted that the battery recharging station 10 may include any number of phone charging tips chosen with the sound judgment of a person of skill in the art. For the embodiment shown, the phone charging tips 22, 24, 26 can be replaced with other phone charging tips of the same type or of a different type. In this way, the battery recharging station 10 can easily be modified to meet the requirements of a particular use. Wiring, circuitry, and other components for communicating the proper amount of current and voltage to the various receptacles may be housed within the battery recharging station body 11.

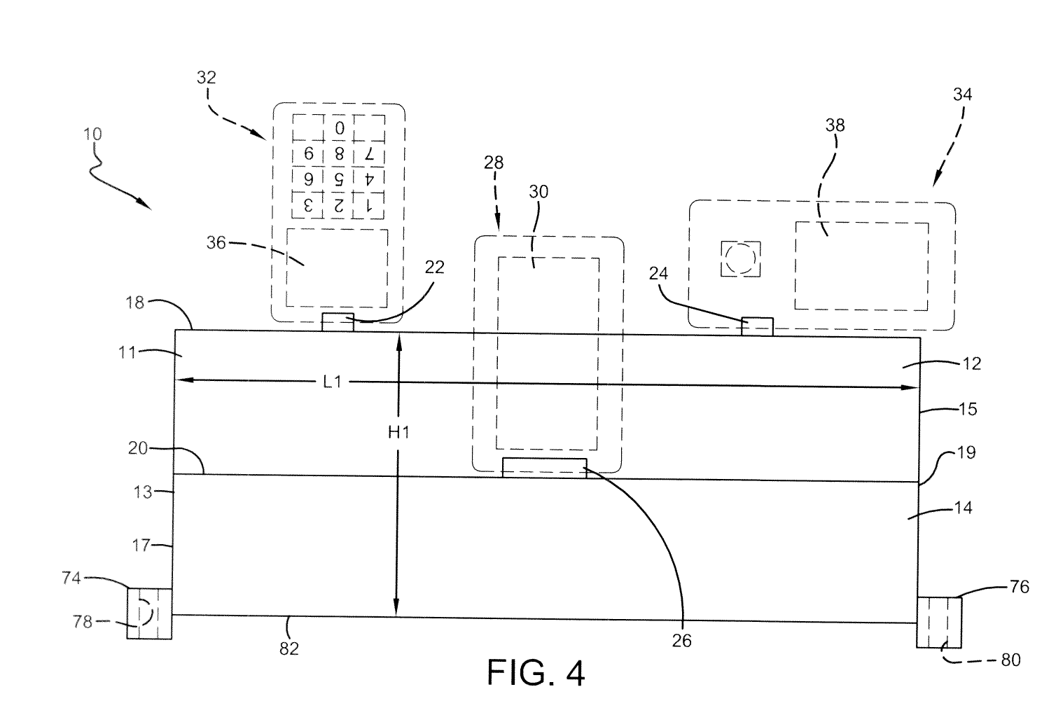

With continuing reference to FIGS. 1, 3, 4, 8 and 9, the surfaces 18 and 20 and the phone charging tips 22, 24, 26 can be arranged such that cellular phones being charged are oriented for display in a direction that is substantially the same as the direction of the display of advertising. Thus, if the owner of the phone receives a message (causing the screen of the phone to illuminate) or if the owner decides to visually check the phone, the owner will perceive the advertising on the surfaces 12 and 14. For the embodiment shown, the first and second substantially horizontal surfaces 18, 20 are not coplanar. In this way they provide two distinct surfaces. FIG. 4 shows three different cellular phones in phantom. The phone charging tip 26 may engage a first phone 28 having a screen 30. The screen 30 is directed in the same direction as the surfaces 12 and 14. The surface 12 is parallel to and recessed from the screen 30. The owner of the first phone 28 will perceive the advertising associated with the surfaces 12 and 14 when viewing the screen 30. FIG. 4 also shows second and third phones 32 and 34, having screens 36 and 38, respectively. The second phone 32 has a female charging receptacle arranged such that, during charging, the screen 36 is upside-down. The third phone 34 has a female charging receptacle arranged such that, during charging, the screen 38 is sideways. Thus, the orientation of the screen of the cellular phone while the cellular phone is mounted on the battery recharging station 10 is not limiting on embodiments of the invention. For all of the phones 28, 32, and 34, the owner will perceive the advertising associated with surfaces 12 and 14 when viewing the respective screen 30, 36, or 38.

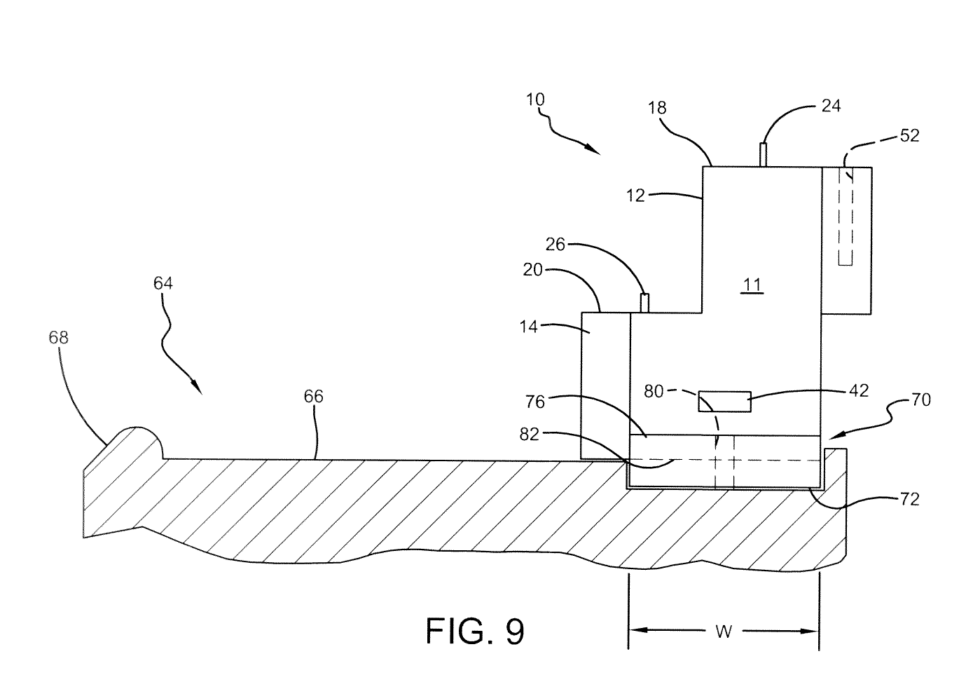

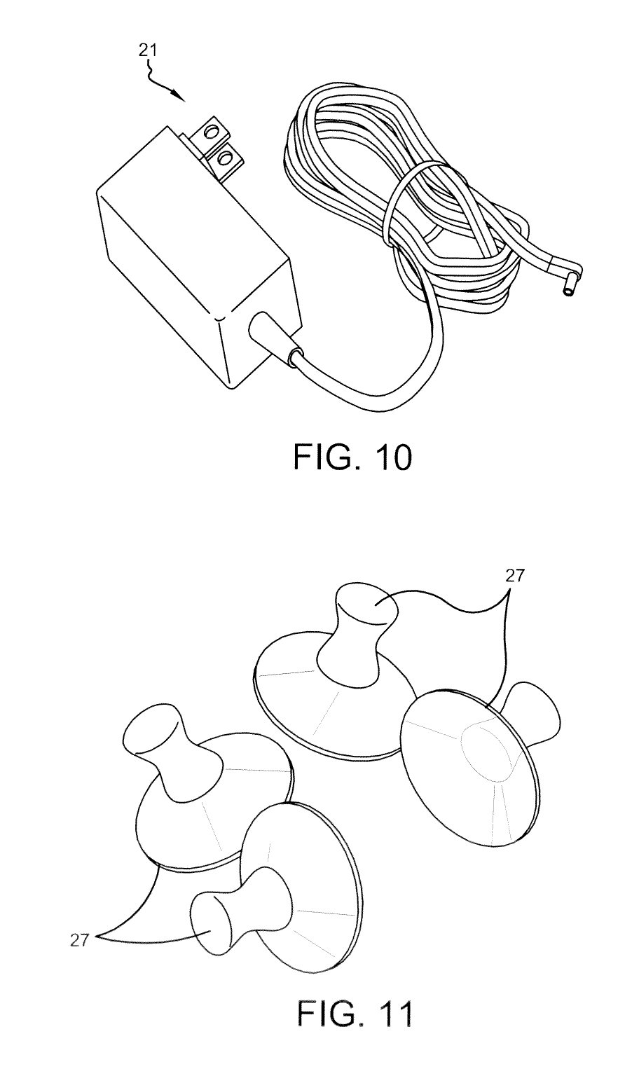

With reference now to FIGS. 1-4, the body 11 may have first and second ends 13 and 15. For the embodiment shown, the first end 13 has a first end surface 17 that is substantially vertical and that is substantially perpendicular to the first and second substantial vertical surfaces 12 and 14 and the second end 15 has a second end surface 19 that is substantially vertical and that is substantially perpendicular to the first and second substantially vertical surfaces 12 and 14. The battery recharging station 10 may include additional receptacles spaced from the surfaces 18 and 20. For example, universal serial bus (USB) ports 40 and 42 (shown in FIGS. 3 and 9 respectively) may be positioned on first and second end surfaces 17, 19, as shown. The USB ports 40, 42 may be desirable to provide additional outlets for charging electronic equipment. In at least some embodiments of the invention, an electrical power cord, such as electrical power cord 21 shown in FIG. 10, may have one end that terminates in a standard two or three prong male connector that is received in an electrical outlet (not shown, but well known to those of skill in the art) and a second end that attaches to the body 11, such as to an aperture 16. The power cord may thus place circuitry housed within the body 11 in electronic communication with a common electrical outlet.

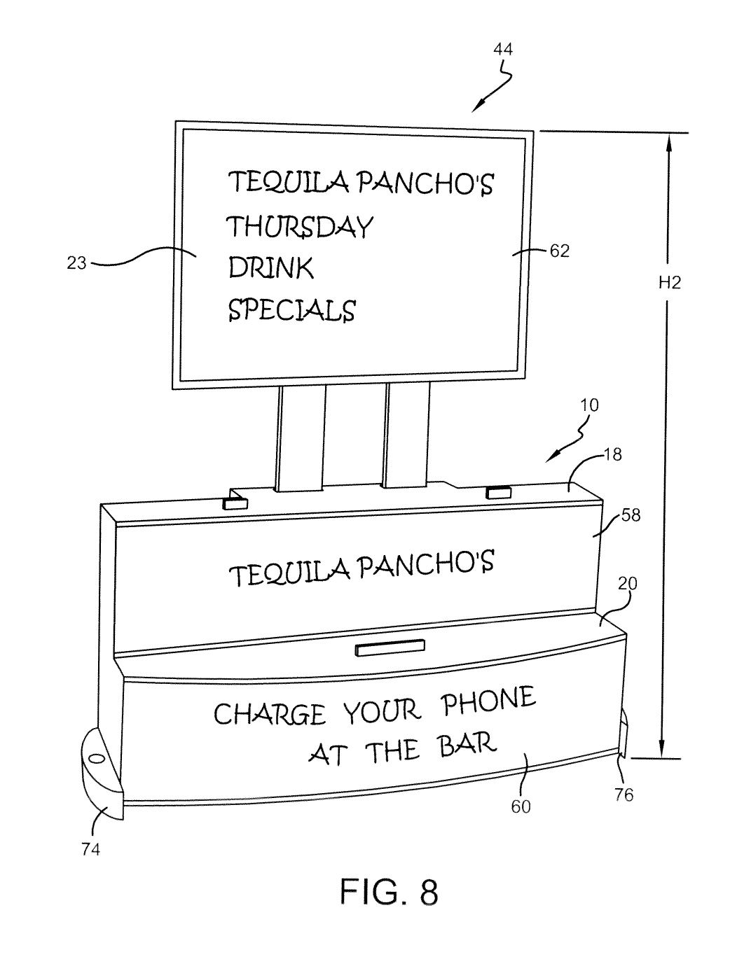

With reference now to FIGS. 1, 3 and 6-9, an optional billboard frame 44 may be engaged with the battery recharging station 10. For the embodiment shown, the billboard frame 44 has first and second posts 46 and 48 that are received that are received in apertures 50 and 52 formed in the body 11 and a substantially vertical surface 25 that is supported to the posts 46, 48. The cooperation between the posts 46, 48 and the apertures 50, 52 can be merely a mechanical connection, wherein the posts 46, 48 and apertures 50, 52 provide structural support for the billboard frame 44. Alternatively, the cooperation between the posts 46, 48 and the apertures 50, 52 can provide both mechanical and electrical connections such that the billboard frame 44 could support electronic advertising. For the embodiment shown, the billboard frame 44 includes upper and lower channels 54 and 56. The upper and lower channels 54 and 56 extend horizontally and are operable to receive an advertisement in the form of printed panel 23, an LCD, a panel of LEDs, or some other structure for advertising. FIG. 8 shows an embodiment applied in an exemplary manner for advertising. The surfaces 12 and 14 are covered by advertising 58 and 60, respectively. The billboard frame 44 is mounted on the battery recharging station 10 and supports advertising 62. The advertising 58, 60, 62 can be printed material, electronic structures such as LCDs or LEDs, or any combination of printed and electronic advertising. It is noted that LEDs can be mounted to one or both of the surfaces 18 and 20 to direct light at one of the items of advertising 58, 60, 62. For the embodiment shown, the surface 12 is above the surface 14 and the surface 25 is above the surface 12. The surfaces 12, 14 and 25 combine with the surfaces 18 and 20 to provide a “stair step” design, as shown.

With reference now to FIG. 9, embodiments of the battery recharging station 10 may be sized and shaped to be received in the drink rail portion of a bar. FIG. 9 shows an end view of the battery recharging station 10 and a portion of a bar 64 in cross-section. The bar 64 has a first side including a counter-top surface 66 for supporting beverages of patrons sitting at the bar 64 on the first side. A raised outer rail 68 may be positioned on the outer edge of the first side of the counter-top surface 66. The bar 64 also has a second side including a drink rail portion 70. The drink rail portion 70 includes a drink rail surface 72 recessed from the counter-top surface 66. The drink rail portion 70 may be used to hold emptied drinking receptacles prior to washing and/or to hold full drinking receptacles that are ready for pick-up by wait-staff. The drink rail portion 70 is desirable to keep the surface 66 as clean as possible.

With reference now to FIGS. 1-5 and 8-9, for the embodiment shown, the battery recharging station 10 is sized and shaped to fit in the drink rail portion 70. At least one foot, two shown 74, 76, may extend from the bottom surface 82 of the body 11. For the embodiment shown, the two feet 74, 76 are positioned on opposite ends of the body 11. The feet 74 and 76 may have widths W2, W3 that are equal to or less than the width W1 of the drink rail portion 70. For the embodiment shown, W2 is equal to W3. The feet 74, 76 can thus be lowered into the drink rail portion 70 and support the battery recharging station 10 to the drink rail portion 70. The feet 74, 76 also substantially prevent undesirable motion of the battery recharging station 10 in the direction of the width W1. The battery recharging station 10 thus remains stable when patrons use it. The feet 74, 76 may also position the bottom surface 82 of the battery recharging station body 11 off the drink rail surface 72 of the drink rail portion 70. As a result, the feet 74, 76 prevent the bottom surface 82 from contacting the drink rail surface 72. Small quantities of liquid might accumulate in the drink rail portion 70 and the feet 74, 76 preclude the battery recharging station 10 from being positioned in such liquid. The feet 74, 76 may also ensure that the surfaces 12 and 14 are positioned fully outside of the drink rail portion 70. In one embodiment, apertures 78 and 80, respectively, can be formed in the feet 74, 76. Fasteners such as bolts (not shown) can be inserted through the apertures 78, 80 and pierce the surface 72 to fix the battery recharging station 10 to the bar 64. In another embodiment, the battery recharging station 10 can be removably secured to the drink rail portion 70 by a clamping mechanism obviating the need for fasteners. In yet another embodiment, one or more suction cups 27 (see FIG. 11) may be used. One end of each suction cup 27 may be attached to the body 11 and the other end may be adhered to the drink rail surface 72 in a known manner. In one embodiment, the suction cups 27 replace the feet 74, 76. In another embodiment, one or more suction cups are used in addition to the feet 74, 76.

With reference now to FIGS. 1-5 and 9, the battery recharging station 10 may have a relatively small size to easily accommodate use at the bar 64. For the embodiment shown, the battery recharging station 10 has a maximum length L1 of 10 inches or less; has a maximum width W4 of 4 inches or less; has a maximum height H1 when the billboard frame is removed from the body of 4 inches or less; and, has a maximum height H2 when the billboard frame is attached to the body of 10 inches or less. In order to provide easy viewing of the advertisements, the surfaces may be at least 5 inches long. In one embodiment, the battery recharging station 10 has a weight (not counting the cellular phones) of about 18 ounces.

With reference now to FIGS. 8-9, to maximize advertising the battery recharging station 10 may be oriented so that the surfaces 12, 14 and 25 (and the advertisements that they support) face the patrons sitting at the first side of the bar 64 when the battery charging station 10 is supported to the drink rail surface 72.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiments disclosed, but that the invention will include all embodiments falling within the scope of the appended claims.

Having thus described the invention, it is now claimed:

I/We claim:

1. A battery charging station for use with an associated bar having first and second sides and comprising: (1) a counter-top surface on the first side of the bar for use in supporting beverages of patrons sitting at the first side of the bar; and, (2) a drink rail portion on the second side of the bar for use in holding emptied drinking receptacles, the drink rail portion comprising a drink rail surface that: (a) is recessed from the counter-top surface; and, (b) has a width W1;
the battery charging station comprising:
a body having a bottom surface, first and second substantially horizontal surfaces that are not coplanar and first and second substantially vertical surfaces that are not coplanar;
a first foot positioned on a first end of the body that extends from the bottom surface of the body, the first foot having a width W2 that is equal to or less than the width W1;
a second foot positioned on a second end of the body that extends from the bottom surface of the body, the second foot having a width W3 that is equal to or less than the width W1;
wherein the first and second feet support the battery charging station to the drink rail surface and prevent the bottom surface from contacting the drink rail surface;
a first phone charging tip that: (1) is supported to the body; (2) extends from the first substantially horizontal surface; (3) supports a first associated cellular phone having a battery to the body; and, (4) charges the battery of the first associated cellular phone;
a second phone charging tip that: (1) is supported to the body; (2) extends from the second substantially horizontal surface; (3) supports a second associated cellular phone having a battery to the body; and, (4) charges the battery of the second associated cellular phone;
a first advertisement that: (1) is supported to the body; (2) is positioned on the first substantially vertical surface; and, (3) faces the patrons sitting at the first side of the bar when the battery charging station is supported to the drink rail surface; and,
a second advertisement that: (1) is supported to the body; (2) is positioned on the second substantially vertical surface; and, (3) faces the patrons sitting at the first side of the bar when the battery charging station is supported to the drink rail surface.

2. The battery charging station of claim 1 further comprising a billboard frame comprising:
first and second posts that are received in apertures formed in the body;
a third substantially vertical surface supported to the first and second posts; and,
a third advertisement that: (1) is positioned on the third substantially vertical surface; and, (2) faces the patrons sitting at the first side of the bar when the battery charging station is supported to the drink rail surface.

3. The battery charging station of claim 2 wherein:
the second substantially horizontal surface is above the first substantially horizontal surface when the battery charging station is supported to the drink rail surface;
the second substantially vertical surface is above the first substantially horizontal surface when the battery charging station is supported to the drink rail surface; and,
the third substantially vertical surface is above the second substantially horizontal surface when the battery charging station is supported to the drink rail surface.

4. The battery charging station of claim 3 wherein:
the body further comprises: (1) a first end having a first end surface that is substantially vertical and that is substantially perpendicular to the first and second substantially vertical surfaces; and, (2) a second end having a second end surface that is substantially vertical and that is substantially perpendicular to the first and second substantially vertical surfaces;
the battery charging station further comprises: (1) a first USB port positioned on the first end surface; and, (2) a second USB port positioned on the second end surface; and,
the battery charging station further comprises: a third phone charging tip that: (1) is supported to the body; (2) extends from one of the first and second substantially horizontal surfaces; (3) supports a third associated cellular phone having a battery to the body; and. (4) charges the battery of the third associated cellular phone.

5. The battery charging station of claim 4 wherein the battery charging station:
has a maximum length of 10 inches or less;
has a maximum width of 4 inches or less;
has a maximum height when the billboard frame is removed from the body of 4 inches or less; and,
has a maximum height when the billboard frame is attached to the body of 10 inches or less.

6. A battery charging station for use with an associated bar having first and second sides and comprising: (1) a counter-top surface on the first side of the bar for use in supporting beverages of patrons sitting at the first side of the bar; and, (2) a drink rail portion on the second side of the bar for use in holding emptied drinking receptacles, the drink rail portion comprising a drink rail surface that: (a) is recessed from the counter-top surface; and, (b) has a width W1; the battery charging station comprising:
a body having a bottom surface;
a first foot that: (1) extends from the bottom surface of the body; (2) has a width W2 that is equal to or less than the width W1; (3) supports the battery charging station to the drink rail surface; and, (4) prevents the bottom surface from contacting the drink rail surface;
a first phone charging tip that: (1) is supported to the body; (2) supports a first associated cellular phone having a battery to the body; and, (3) charges the battery of the first associated cellular phone;
a second phone charging tip that: (1) is supported to the body; (2) supports a second associated cellular phone having a battery to the body; and, (3) charges the battery of the second associated cellular phone;
a first advertisement that: (1) is supported to the body; (2) faces the patrons sitting at the side of the bar when the battery charging station is supported to the drink rail surface; and, at least 5 inches long; and,
wherein the battery charging station: (1) has a maximum length of 10 inches or less; (2) has a maximum width of 4 inches or less; and, (3) has a maximum height of 4 inches or less.

7. The battery charging station of claim 6 wherein:
the body has a first substantially vertical surface and the first advertisement is positioned on the first substantially vertical surface; and,
the battery charging station further comprises a billboard frame comprising:
first and second posts that are received in apertures formed in the body;
a second substantially vertical surface supported to the first and second posts; and, a second advertisement that: (1) is positioned on the second substantially vertical surface; and, (2) faces the patrons sitting at the first side of the bar when the battery charging station is supported to the drink rail surface;
wherein the battery charging station has a maximum height of 4 inches or less without the billboard frame; and,
wherein the battery charging station has a maximum height of 10 inches or less when the billboard frame is attached to the body.

8. The battery charging station of claim 6 wherein:
the body has a first substantially vertical surface and the first advertisement is positioned on the first substantially vertical surface;
the body has a second substantially vertical surface that is not coplanar with the first substantially vertical surface; and,
the battery charging station further comprises a second advertisement that: (1) is supported to the body; (2) is positioned on the second substantially vertical surface; (3) faces the patrons sitting at the first side of the bar when the battery charging station is supported to the drink rail surface; and, (4) is at least 5 inches long;

9. The battery charging station of claim 6 wherein:
the body comprises first and second substantially horizontal surfaces that are not coplanar;
the first phone charging tip extends from the first substantially horizontal surface; and, the second phone charging tip extends from the second substantially horizontal surface.

10. The battery charging station of claim 9 further comprising:
a third phone charging tip that: (1) is supported to the body; (2) extends from one of the first and second substantially horizontal surfaces; (3) supports a third associated cellular phone having a battery to the body; and, (4) charges the battery of the third associated cellular phone.

11. The battery charging station of claim 10 wherein:
the first phone charging tip is a micro USB charging tip;
the second phone charging tip is an iPhone charging tip; and,
the third phone charging tip is a micro USB charging tip.

12. The battery charging station of claim 6 wherein:
the first foot is positioned on a first end of the body; and,
the charging station further comprises: a second foot that: (1) is positioned on a second end of the body; (2) extends from the bottom surface of the body; (3) has a width W3 that is equal to or less than the width W1; (4) supports the battery charging station to the drink rail surface; and, (5) prevents the bottom surface from contacting the drink rail surface.

13. The battery charging station of claim 6 wherein:
the body further comprises first and second end surfaces; and,
the battery charging station further comprises: (1) a first USB port positioned on the first end surface; and, (2) a second USB port positioned on the second end surface.

14. The battery charging station of claim 6 further comprising:
first and second suction cups that: (1) are attachable to the body; and, (2) are adhereable to the drink rail surface.

15. A method comprising the steps of:
(A) providing a bar having first and second sides and comprising: a counter-top surface on the first side of the bar for use in supporting beverages of patrons sitting at the first side of the bar; and, a drink rail portion on the second side of the bar for use in holding emptied drinking receptacles, the drink rail portion comprising a drink rail surface that is recessed from the counter-top surface; and, has a width W1;
(B) providing a battery charging station comprising: a body having a bottom surface; a first foot that extends from the bottom surface of the body and has a width W2 that is equal to or less than the width W1; a first phone charging tip that is supported to the body; a second phone charging tip that is supported to the body; and, a first advertisement that is supported to the body;
(C) supporting the battery charging station to the drink rail portion by placing the first foot onto the drink rail surface so that: (1) the bottom surface is prevented from contacting the drink rail surface; and, (2) the first advertisement faces the patrons sitting at the first side of the bar;
(D) attaching a power cord from an associated electrical outlet to the body; and, (E) engaging a first associated cellular phone having a battery to one of the first phone charging tip and the second phone charging tip to: (1) support the first associated cellular phone to the body; and, (2) charge the battery of the first associated cellular phone.

16. The method of claim 15 further comprising the step of:
replacing one of the first phone charging tip and the second phone charging tip with a third phone charging tip.

17. The method of claim 15 wherein step (B) comprises the steps of:
providing the first phone charging tip to be a micro USB charging tip;
providing the second phone charging tip to be an iPhone charging tip; and,
providing a third phone charging tip that is a micro USB charging tip and that is supported to the body.

18. The method of claim 17 wherein step (B) further comprises the steps of:
providing a first USB charging port on a first end of the body; and,
providing a second USB charging port on a second end of the body.

19. The method of claim 15 wherein:
prior to step (C) the method comprises the steps of: (1) providing at least two suction cups; and (2) attaching the suction cups to the body; and,
step (C) comprises the step of: adhering the suction cups to the drink rail surface.

20. The method of claim 15 further comprising the steps of:
providing a billboard frame comprising first and second posts and a substantially vertical surface;
inserting the first and second posts into first and second apertures formed in the body so that the substantially vertical surface faces the patrons sitting at the first side of the bar; and,
placing a second advertisement onto the substantially vertical surface.
